(19) United States
(12) Patent Application Publication
(10) Pub. No.: US 2016/0021868 A1
(43) Pub. Date: Jan. 28, 2016

(54) GAME SLED

(71) Applicant: Vince Martinez, Filmore, UT (US)

(72) Inventor: Vince Martinez, Filmore, UT (US)

(21) Appl. No.: 14/809,052

(22) Filed: Jul. 24, 2015

Related U.S. Application Data
(60) Provisional application No. 62/030,017, filed on Jul. 28, 2014.

(51) Int. Cl. A01M 31/00; B62B 15/00

(52) U.S. Cl. CPC A01M 31/006; B62B 15/007

(57) ABSTRACT

A portable game sled for towing a carcass has a flexible sheet that can be carried and unrolled when required. The sheet has legs holes through which legs of the carcass can be inserted to secure the carcass to the sheet. The game sled may also include stitch holes at least partially around a perimeter to allow the sheet to be stitched around the carcass, thereby securing the carcass within. At one end of the sheet there is a sleeve reinforced by a pipe that receives a tow rope. The pipe may be welded to the sheet to provide secure attachment of the pipe and reinforcement of the sleeve.

### CROSS REFERENCE TO RELATED APPLICATIONS

This application claims priority to U.S. provisional patent application serial number 62/030017, filed 28 Jul. 2014, the contents of which are herein incorporated by reference.

### FIELD OF THE INVENTION

The present invention relates to hunting aids and the like and in particular to sleds for transporting game.

### BACKGROUND

There exists a problem in hunting large game of transport of a dead animal from the kill site to a hunter's transport vehicle. In many cases, game needs to be hauled through variable terrain including swampland, woodlands, brush and over rocks, snow, etc. This can be an extremely demanding task for various large animals.

What is required is an improved system for transporting game.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to tow a carcass;

the ability to secure the carcass to a flexible sheet using leg holes provided in the sheet;

the ability to stitch the sheet around the carcass;

enhanced longevity of a portable game sled by use of reinforcement at the towing attachment point; and

enhanced longevity of the game sled by use of plastic welding techniques to reinforce the contact points of the game sled.

These and other advantages may be realized by reference to the remaining portions of the specification, claims, and abstract.

Brief Description of One Embodiment of the Present Invention

In one aspect, there is provided a game sled for towing a carcass. The game sled may include a flexible sheet for wrapping around the carcass. A plurality of stitch holes may be provided adjacent a perimeter of the sheet. The stitch holes receive a rope, cord or similar for stitching the sheet around the carcass to secure the carcass within the sheet. To enhance the securing of the carcass, one or more leg holes may be provided for receiving one or more legs of the carcass such that the one or more legs of the carcass protrude through the one or more leg holes.

In one aspect, there is provided a method for towing a carcass. In the method, a carcass may be laid on a flexible sheet. One or more legs of the carcass may be inserted through one or more leg holes of the sheet. The sheet may then be wrapped around the carcass with the one or more legs of the carcass protruding through the one or more leg holes. The sheet may be secured around the carcass, e.g. by stitching the sheet through one or more stitch holes. The wrapped carcass can then be towed.

In one aspect, there is provided a game sled for towing a carcass. The game sled may include sheet means for wrapping a carcass, leg hole means for receiving one or more legs of the carcass such that the one or more legs of the carcass protrude through the leg hole means, and stitch hole means for stitching the sheet means around the carcass.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially shows an animal transport sled;

FIG. 2 substantially shows the animal transport sled in a stage of manufacture;

FIG. 3 substantially shows the completed animal transport sled; and

FIG. 4 substantially shows the top edge of the animal transport sled.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

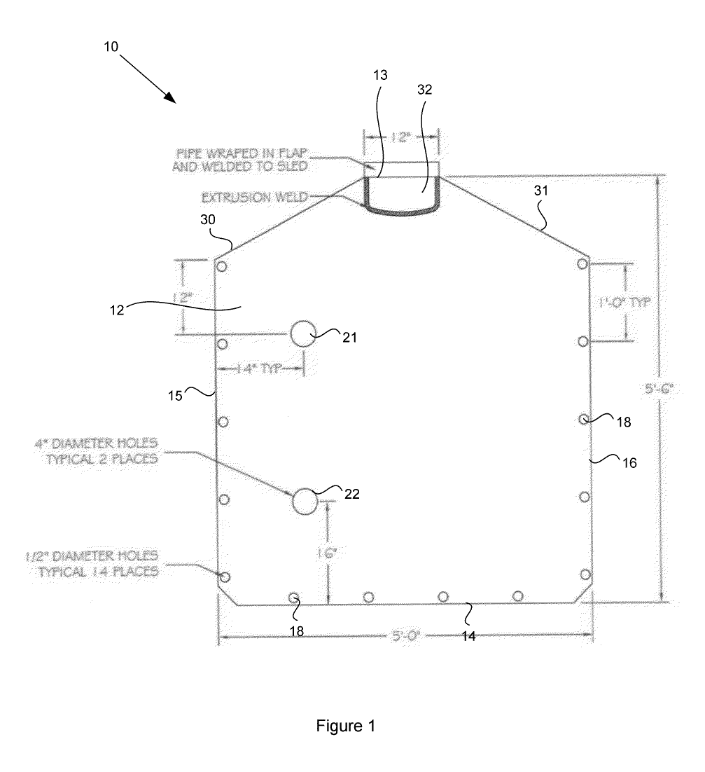

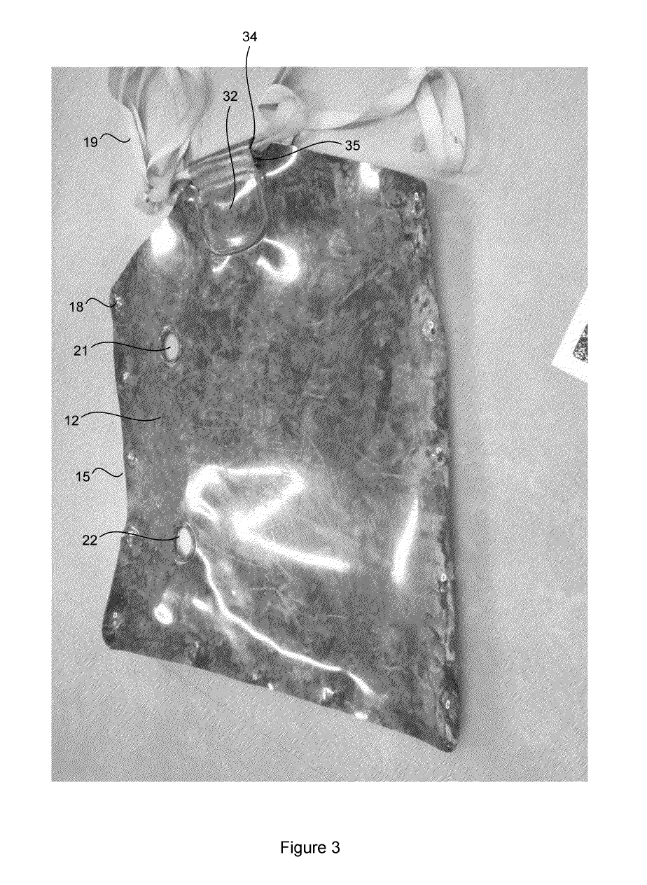

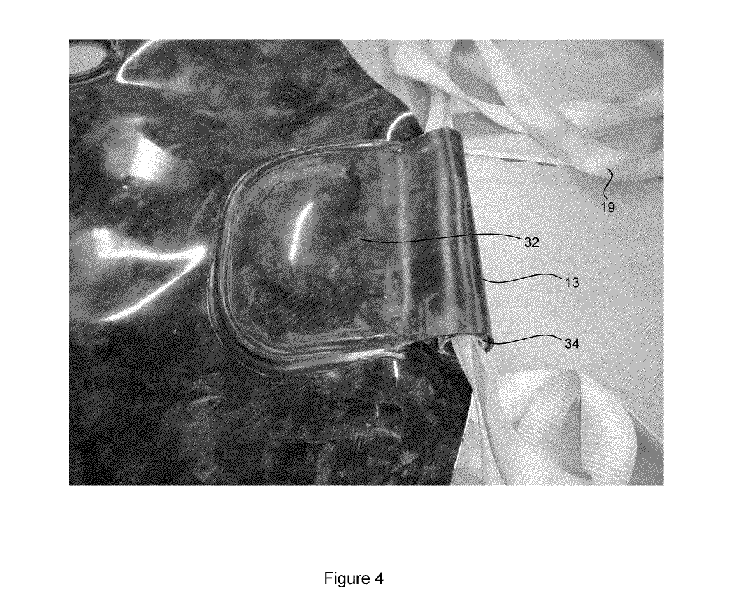

FIGS. 1-4 show an animal sled in accordance with one embodiment of the present invention. The sled 10 includes a sheet of material 12. The sheet may be High Density Polyethylene (HDPE). In one embodiment, the sheet 12 may be 80 mls (2 mm). HDPE is strong yet flexible and has a suitably low friction coefficient.

The sheet 12 may be generally rectangular in shape having a top edge 13, bottom edge 14 and side edges 15, 16. The sheet 12 may have a longitudinal axis extending from the top edge 13 to the bottom edge 14. In one embodiment, the sheet is approx 5′6″ long and approx 5′0″ wide. The sheet may include additional profiling, e.g. trimmed corners, as shown in FIG. 1. The particular size and shape of the sled 10 described and depicted herein is but one embodiment and other sizes and shapes will be apparent to the person skilled in the art.

The sled 10 may include a plurality of holes 18 around a perimeter of the sheet 12, e.g. adjacent edges 14, 15, 16. The holes 18 may be approx ½ inch in diameter. In one embodiment, there are five holes along each side edge 15, 16 and four holes along the bottom edge 14. The holes 18 may be reinforced with a grommet or the like which may be bonded or welded into the sheet 12.

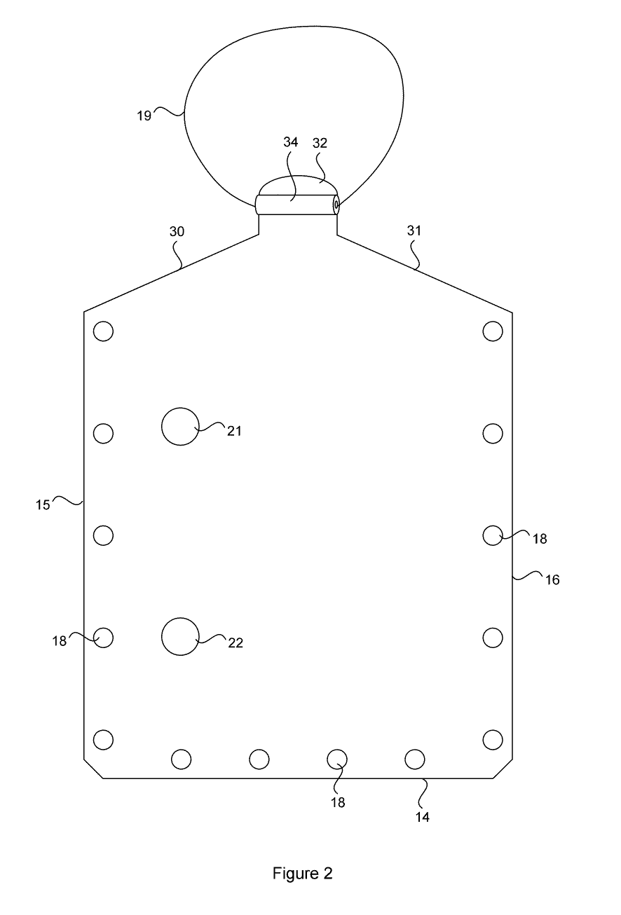

The top edge 13 is the edge by which the sled 10 may be dragged. The top edge 13 may therefore be formed with a reinforcement that enables a rope 19 or similar to be attached to the sled as well as providing a reinforcement at this location, being the location of the sled that will be subject to the highest loads. FIG. 2 shows the sheet in a configuration prior to the inclusion of the reinforcement. The top edge includes a first angled side 30 extending from the first side 15 and a second angled side 31 extending from the second side 16. Extending upwards of the first and second angled sides 30, 31 is a projection 32. The projection may be folded downward about the points at the top of the angled sides 30, 31 to create a sleeve 35. A section of pipe 34 may be located in the sleeve. The pipe 34 may be adhered or welded within the sleeve, e.g. by joining the pipe 34 to the projection 32 prior to folding the projection. After folding the projection, the end section of the projection may be welded or otherwise adhered or secured to the sheet body so that the pipe 34 is located permanently within the sleeve.

A rope or cord 19 may be threaded through the pipe 34 to provide a means for towing the sled 10. Any suitable tow device may be employed including cables, chains, etc. The fold and weld of the projection provides a strong contact and tow point on the sheet 12 while the pipe prevents tearing of the material of the sheet 12 at the sleeve.

Inward of at least one side edge, e.g. edge 15, there may be provided a plurality of leg holes 21, 22. The leg holes are sized to receive the leg of the game animal. In one embodiment, two leg holes 21, 22 are provided for receiving one or more legs of an animal. Each leg hole may have a diameter of approximately 4″. The leg holes 21, 22 may be reinforced with a grommet or the like which may be bonded or welded into the sheet 12. Any number of leg holes may be provided for securing the carcass in the best way possible. Each leg hole may be sized to receive a single leg of the animal or may be sized to receive two legs of the animal.

In use, when an animal is hunted, the dead animal may be located on the sheet 12. The front and rear legs on one side of the animal may be placed through the leg holes 21, 22 so that the body lies along the longitudinal axis of the sled. The sheet may be wrapped around the animal and then a rope or cord may be laced through the edge holes 18, alternating from one side edge 15 to the other side edge 16. The laced cord can also be threaded through the bottom edge 14. The laced cord secures the sled around the animal, thereby securing the animal on the sled 10. The sled 10 may then be dragged by a drag rope 19 secured through the pipe 34. It should be noted that not all of the stitch holes need to be utilized. In particular, the stitch holes on the bottom edge may be omitted if the animal is too large. Though not shown, additional stitch holes may also be provided on the top edges 30, 31 if required.

The sled 10 may be rolled up, folded or otherwise compacted for easy transport when hunting. The sled 10 may be secured in the compact position by the drag rope 19 or by cord used to tie the animal into the sled 10. When required, the sled 10 may be opened out for securing around the animal.

An advantage of the sled is that the leg holes 21, 22 provide a means for positively securing the animal to the sled 10 in a manner that prevents the animal from falling off the sled 10. In addition, the leg holes 21, 22 assist in holding the sled on the animal when initially securing the animal to the sled, e.g. by enabling the animal to be rolled or otherwise maneuvered while on the sled.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A game sled for towing a carcass, the game sled comprising:
(A) a flexible sheet for wrapping around the carcass, the flexible sheet comprising a perimeter;
(B) a plurality of stitch holes adjacent the perimeter, the plurality of stitch holes for receiving a rope for stitching the flexible sheet around the carcass to secure the carcass within the sheet; and
(C) one or more leg holes inward of the plurality of stitch holes, the one or more leg holes for receiving one or more legs of the carcass such that the one or more legs of the carcass protrude through the one or more leg holes.

2. The game sled of claim 1 wherein the perimeter comprises a first edge and an opposite second edge that define a length of the flexible sheet and wherein the plurality of stitch holes are provided adjacent each of the first edge and the second edge.

3. The game sled of claim 2 wherein the at least one leg hole is provided nearer to the first edge than the second edge.

4. The game sled of claim 2 wherein the perimeter comprises a third edge and an opposite fourth edge that define a width of the flexible sheet, wherein the plurality of stitch holes comprises one or more stitch holes adjacent the third edge.

5. The game sled of claim 4 wherein the fourth edge comprises a reinforcement.

6. The game sled of claim 5 wherein the reinforcement comprises a sleeve.

7. The game sled of claim 6 wherein the sleeve comprises a folded section of the flexible sheet that is welded to itself to form the sleeve.

8. The game sled of claim 6 wherein the reinforcement comprises a pipe within the sleeve.

9. The game sled of claim 8 wherein the pipe is welded to the sleeve.

10. The game sled of claim 1 comprising at least two leg holes.

11. The game sled of claim 1 comprising:
(A) a reinforced sleeve;
(B) a rope attached through the reinforced sleeve for towing the game sled.

12. A method for towing a carcass comprising:
(A) laying the carcass on a flexible sheet;
(B) protruding one or more legs of the carcass through one or more leg holes of the sheet;
(C) wrapping the sheet around the carcass with the one or more legs of the carcass protruding through the one or more leg holes;
(D) securing the wrapped sheet around the carcass to wrap the carcass; and
(E) towing the wrapped carcass.

13. The method of claim 12 wherein securing the wrapped sheet around the carcass comprises stitching the wrapped sheet through a plurality of stitch holes.

14. The method of claim 13 comprising attaching a tow rope to the flexible sheet and towing the wrapped carcass using the tow rope.

15. The method of claim 14 wherein attaching the tow rope comprises threading the tow rope through a sleeve formed in the flexible sheet.

16. The method of claim 15 wherein the sleeve comprises a reinforcement.

17. A game sled for towing a carcass, the game sled comprising:
(A) sheet means for wrapping a carcass;
(B) stitch hole means for receiving a rope for stitching the sheet means around the carcass to secure the carcass within the sheet means; and
(C) leg hole means for receiving one or more legs of the carcass such that the one or more legs of the carcass protrude through the leg hole means.

18. The game sled of claim 17 comprising sleeve means for securing a tow rope.

19. The game sled of claim 18 comprising reinforcement means for reinforcing the sleeve means.

20. The game sled of claim 19 wherein the reinforcement means is welded to the sheet means.
